(19) United States
(12) Patent Application Publication
(10) Pub. No.: US 2009/0205042 A1
(43) Pub. Date: Aug. 13, 2009

(54) EXTERNAL USER INTERFACE BASED MEASUREMENT ASSOCIATION

(75) Inventors: Brian Zhou, San Jose, CA (US); Daniel A. Simms, Sunnyvale, CA (US); Imtiyaz Haque, Cupertino, CA (US); John C. Ryan, Boston, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,091

(22) PCT Filed: Dec. 8, 2006
(86) PCT No.: PCT/US2006/061775

§ 371 Date: Oct. 9, 2008

Related U.S. Application Data
(60) Provisional application No. 60/750,535, filed on Dec. 15, 2005.

(51) Int. Cl. G06Q 10/00; G06Q 50/00; G06F 21/00

(52) U.S. Cl. 726/19; 705/3; 715/764

(57) ABSTRACT

A health management system (10) comprises a user interface (48) which enables an entry of a patient identification. An association device or means (130, 152) associates the biometric data acquired by medical monitoring devices (82₁, 82₂, . . . ) with the entered patient identification.

The following relates to the health management arts. It finds particular application in conjunction with the patient identification and association to medical devices at home and will be described with particular reference thereto. However, it is to be appreciated that the invention will also find application in conjunction with patient monitoring in retirement communities, assisted living, pharmacies, community centers, and the like.

The outpatient or remote health care management system typically connects chronically ill patients and health care providers via interactive health care communication platform, which, for example, uses the patient home television set interactively. The patients use the medical devices which are installed in their homes to measure vital signs such as blood pressure, heart rate, blood oxygen, weight, and the like. The patient's biometric data is automatically sent via secured signal connection links to the supervising health care providers. The health care providers monitor the patients health by setting up the flags for clinical reviews if one of the vital sign measurements falls outside the normal range. In addition, the health care professionals can support the patients by sending them reminders, educational videos, and the like.

While the remote health care management system functions well for a single patient at one location, many of the patients are elderly and their spouses also have medical problems. If the elderly couple shares the medical monitoring device, it is problematic for the remote health care management system to distinguish whose measurements are being taken.

One approach is to provide each patient with a personal medical monitor which can be individually addressed, to communicate through an interactive TV set top box. Not only does the purchase of two medical monitors for a single home doubles the costs, but the medical monitors including the memory and logic to identify patients, respond to queries, and the like, are considerably more expensive than the basic, simple medical monitors which can be used if there is only a single patient to address. The costs escalate when a plurality of patients reside at the same dwelling such, as for example, in a retirement home.

Shared units must have an interface that allows for accessing the corresponding patient data. This would include providing the corresponding content, history, assessment and goal modules. Since these are patient specific details, a shared unit must be able to recognize the patient and associate this data with the corresponding patient. In addition, data input on the patient side, either directly into the system or through an monitoring interface, must associate the data with the correct corresponding patient.

In addition, patients may not want to share certain portions of their own medical histories and thus may only want to share certain portions or even may desire complete privacy from others that use a shared station. This would be especially true for common use among retirement communities, assisted living, pharmacies, community centers and the like where patients are not necessarily acquainted with all persons sharing the station.

There is a need for methods and apparatuses that overcome at least some of the shortcomings described above.

In accordance with one aspect, a health management system is disclosed. A user interface enables an entry of a patient identification. An association device or means associates the biometric data acquired by medical monitoring devices with the entered patient identification.

In accordance with another aspect, a health management system is disclosed. A plurality of biometric devices is disposed at a patient station to acquire medical biometric data of patients. A measurement gateway is assigned to the patient station and is in operative communication with the biometric devices of the patient station to transmit the acquired medical biometric data of the patients to a remote station. An external device enables a manual entry of a patient identification by a user, the external device being disposed externally to the biometric devices. An association computer routine associates the biometric data acquired by each medical monitoring device with the entered patient identification.

In accordance with another aspect, a health management method is disclosed. Biometric data of one or more patients is acquired with biometric medical devices which lack identification components. The biometric data acquired by the medical monitoring devices are associated with a patient identification.

The following may take form in various components and arrangements of components, and in various process operations and arrangements of process operations. The drawings are only for the purpose of illustrating preferred embodiments and are not to be construed as limiting the following.

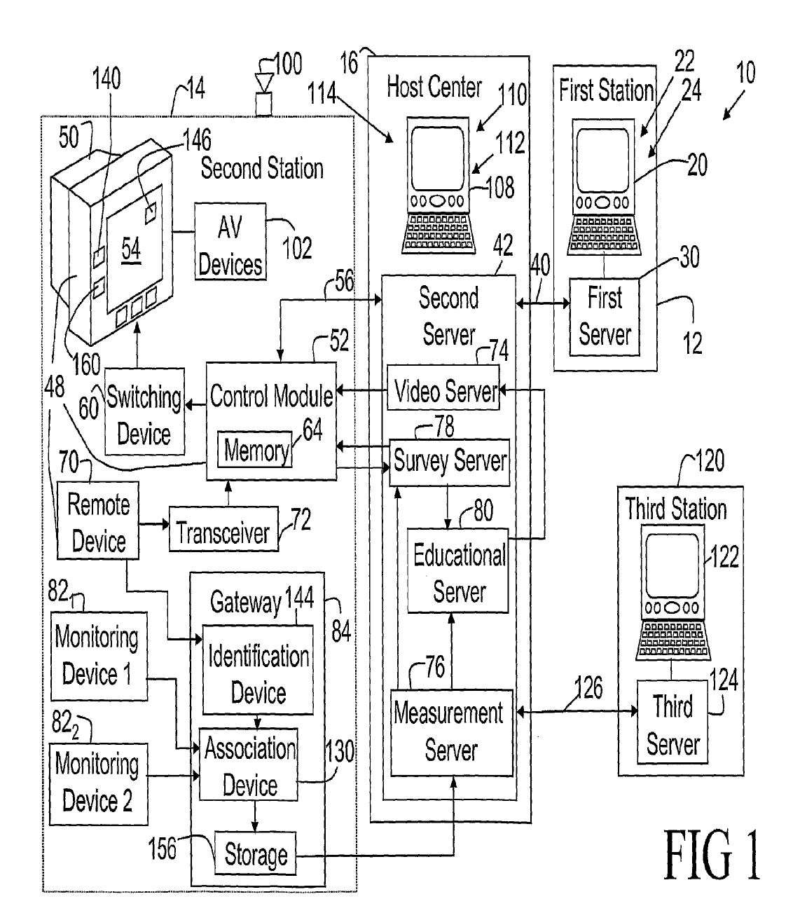

FIG. 1 diagrammatically shows principal components of an exemplary health management system;

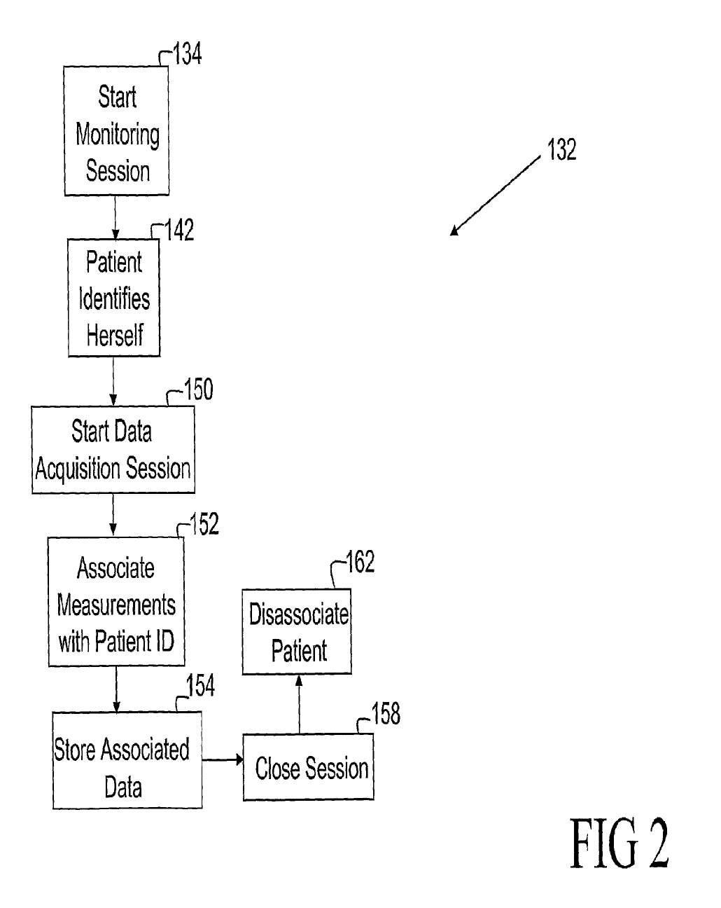

FIG. 2 is a flow chart of an exemplary monitoring session;

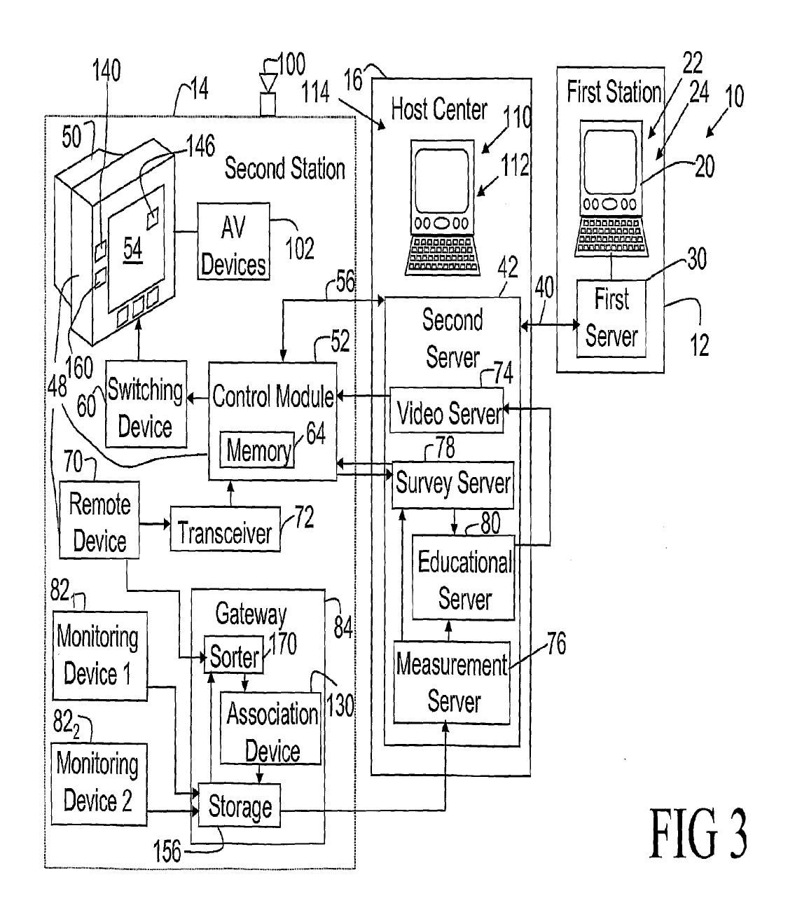

FIG. 3 diagrammatically shows a portion of the health management system;

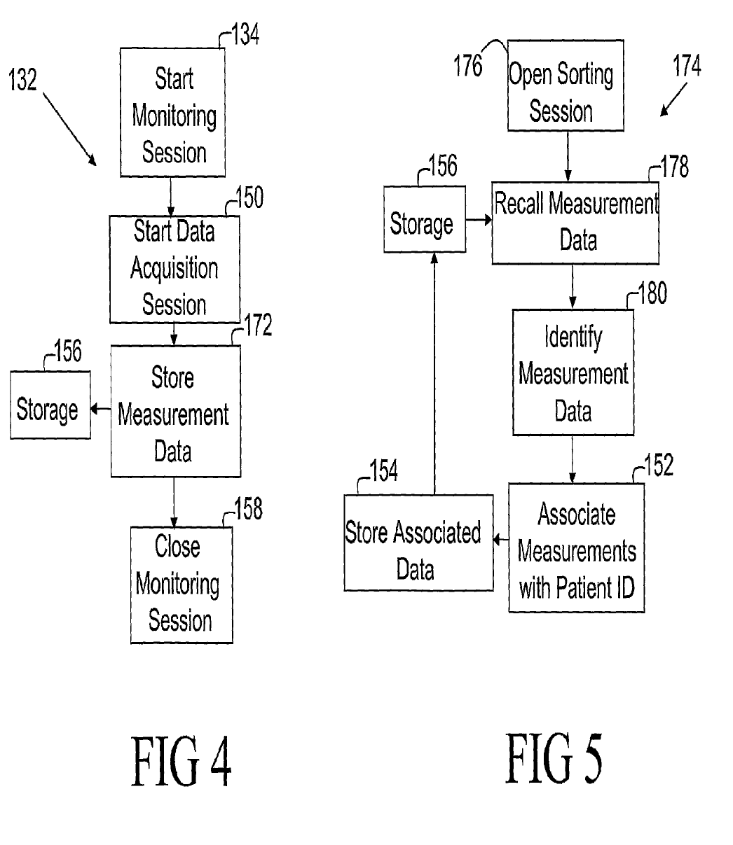

FIG. 4 is a flow chart of an exemplary monitoring session;

FIG. 5 is a flow chart of an exemplary sorting session;

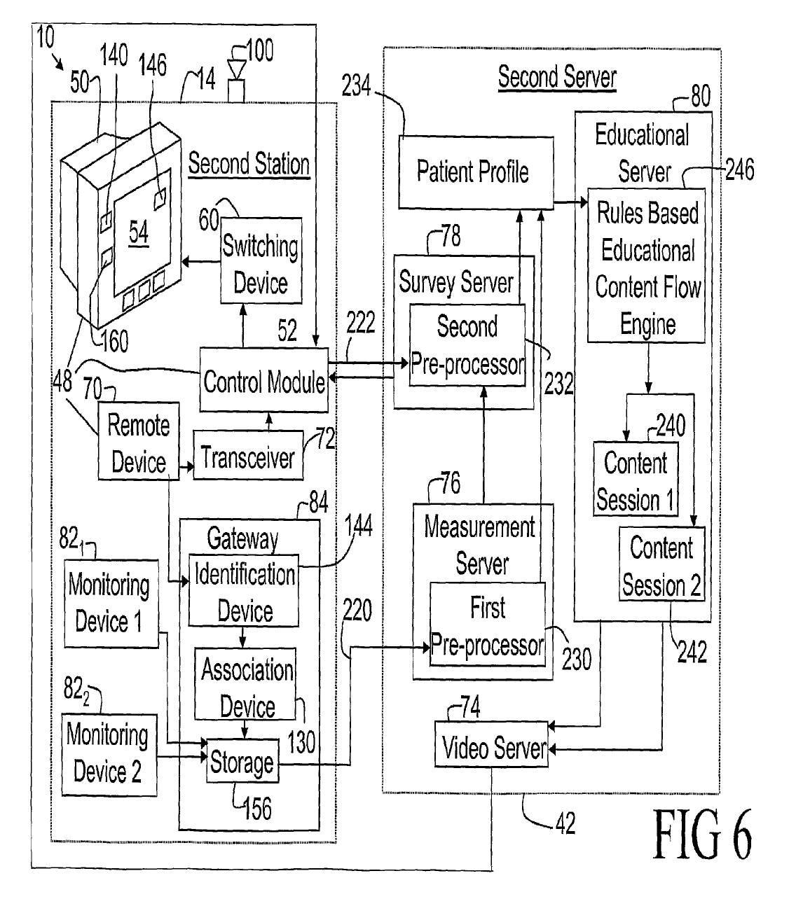

FIG. 6 diagrammatically shows a portion of the health management system;

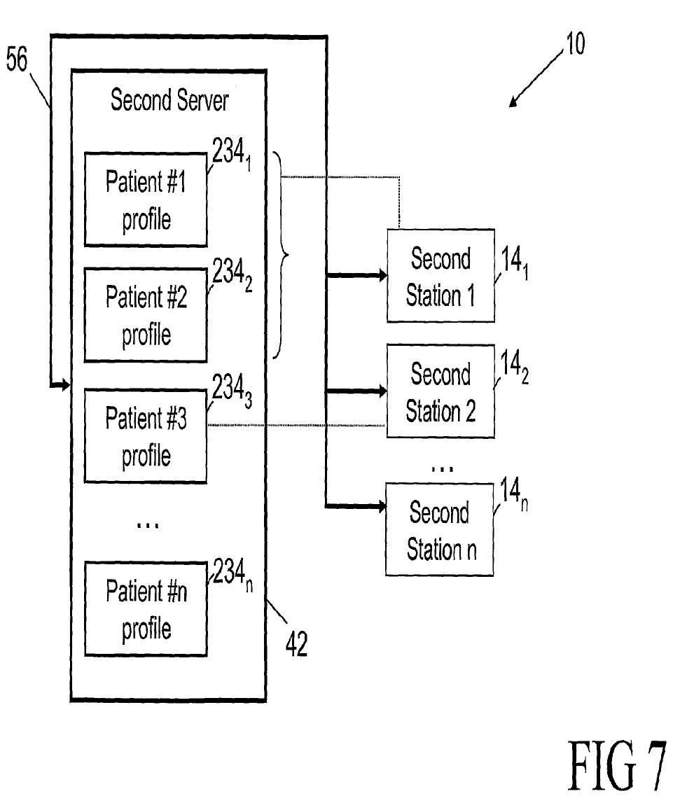

FIG. 7 diagrammatically shows a suitable relatively centralized arrangement of components of the health management system; and

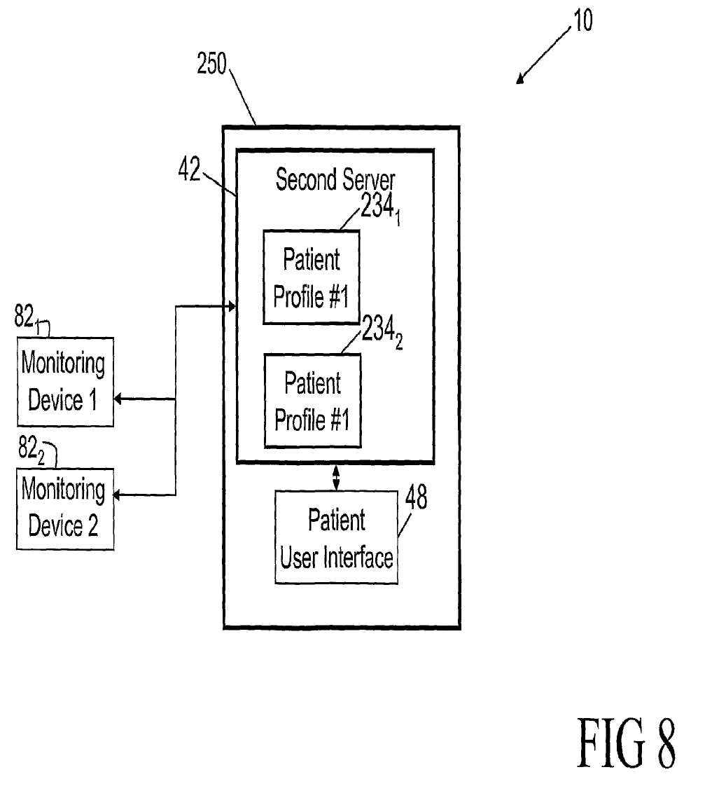

FIG. 8 diagrammatically shows a suitable relatively decentralized arrangement of components of the health management system of.

With reference to FIG. 1, a health management system 10 includes first or care provider station 12, or patient's station 14 and a host center 16. The first or care provider station 12 is located, for example, at a care provider site such as a physician's office or hospital and includes a terminal 20. One example of the terminal 20 is a personal computer which includes an appropriate software 22, such as user interface software, and hardware 24, for interfacing with the host center 16 and the second or patient station 14. The terminal 20 is connected to a first server 30 via an intranet connection as known in the art.

Of course, it is contemplated that the health management system 10 can include a plurality of the first stations 12, a plurality of host centers 16 and a plurality of second stations 14 as appropriate for an application. Each host center 16 is typically connected with a multiplicity of patient stations 14 and a large number of care giver stations 12. One care giver typically monitors a plurality of patients. Analogously, one patient may have several care givers.

A first link 40, e.g. internet, provides the connection between the first station 12 and the host center 16. Alternatively, the first station 12 is a wireless station of a wireless local area network (LAN) or wireless wide are network (WAN).

The second station 14 includes an interactive user or patient interface 48 which includes a television set 50 or other patient display device which is located in a patient's home or dwelling. The user interface 48 further includes a control module or processor or algorithm or means 52, such as set-top box, which interfaces with a video display 54 of the television set 50. The control module 52 converts and displays data from analog cable, digital cable, satellite, or digital broadcast television to a standard channel frequency, e.g. channel number, for display, for example, on a standard analog television set 50, computer monitor, or the like. In one embodiment, the control module 52 further receives off-air digital television (DTV) signals for display on a DTV monitor. The control module 52 receives signals such as standard television signals and patient information signals from the host center 16 via a second link 56. The examples of the second link 56 are wired connection, satellite connection, wireless connection, fiber optic connection, and other two-way communication links.

The control module 52 is connected to the video display 54 via a switching device or algorithm or means 60 such as an audio/video (AV) switching device as known in the art. The switching device 60 provides switching between television reception from the tuner of the display 54 and patient information reception/transmission from/to the host center 16. Alternatively, any other known type of input device adapted to provide an interface to the video display 54 is used.

For example, the patient information signals include information, instructions, surveys, and queries that are displayed on the video display for information, action, and the like. The patient information signals also include video and audio health issue programs, audio programs, video messages and audio messages, reminders to sent health or biometric information and the like. For example, the control module 52 includes a memory 64 so that patient information signals are stored for later use, e.g. time-shifted display. When the switching device 60 is configured to transmit the patient information signals, the control module 52 retrieves the patient information signals from the memory 64 to the display 54 or forwards the signals as received from the host center. The user interface 48 further includes a remote interface device 70 which provides signals to transceiver 72, e.g. an infrared or RF transceiver. Signals from the transceiver 72 are provided to the control module 52 and function to select video input to the video display 54, input patient information, and the like. In one embodiment, the remote interface device 70 is a remote control device such as one commonly used in the home entertainment systems. In another embodiment, the remote interface device 70 is a computer input interface device, such as a keyboard or a mouse.

The host center 16 is centralized and includes various servers for specific functions. The examples of servers of the host center 16 are a video server 74, which provides pertinent video content to the display 54, a measurement server 76, which receives the measurements of biometric or physiological data, a survey server 78 which generates surveys, an educational server 80 which generates and delivers medically oriented educational sessions, and others. However, it is contemplated that the host center 16 is distributed, with different components or sub-centers hosting different functions. Alternatively, there may be a plurality of host centers 16 that connect a plurality of second stations 14 with one or more first stations 12.

The second station 14 includes a set of patient medical or monitoring or biometric devices 82₁, 82₂, . . . . The examples of the patient monitoring devices 82₁, 82₂ include a weight scale, a blood pressure device, an electrocardiogram, an electroencephalogram, an oximeter, a brain wave measuring device, a respiration monitor, a thermometer, and the like. Although only two monitoring devices are illustrated, it is contemplated that a set of monitoring devices can include one, three, four, five devices, etc. In a typical arrangement, the user is located at a dwelling such as a house, apartment, assisted living apartment, or so forth, and does not have ready direct access to medical personnel. Accordingly, in some embodiments, the biometric devices 82₁, 82₂ are advantageously designed to be simple to operate. For example, a fingertip SpO₂ monitor can be used to provide both saturated blood oxygen level and heart rate simply by clipping the fingertip monitor onto the patient's fingertip. The biometric devices can be wireless devices which are worn by the patient and communicate biometric readings continuously or at intervals to the host center, can be cabled devices which the patient uses one or more times a day to take readings, or the like. Additionally, or alternatively, certain measurements may be manually entered by the patient via the remote device 70. Alternatively, one or more biometric devices 82₁, 82₂ can be implanted in the patient, such as a sensor on a pacemaker, on an infusion pump, and the like. Collected monitored or manual patient data are provided to a measurement gateway 84, which transmits the data to the measurement server 76 for processing. Optionally, the collected monitored or manual patient data is filtered by a pre-processor. For example, the blood pressure is verified using ECG signals to identify erroneous signals or artifacts, which are ignored or discarded. Filtering might also include parsing the collected data into one or more groups of related information such as grouping ECG signals, etc. Signals in the group are compared for consistency with each other, and signals which are inconsistent with the group are discarded or ignored.

Other exemplary user interface devices are a personal computer (PC), personal digital assistant (PDA), a mobile phone, a portable computer, automated voice response system, and the like. As such, the display is accordingly a computer monitor, handheld communication device display, such as a portable phone, cellular phone or PDA.

In one embodiment, the second station 14 includes an RF interface 100 such as an antenna and audio/video (AV) devices 102 which provide links to the second station 14. The examples of the AV devices 102 are a video cassette recorder (VCR), a digital video disc (DVD) player, a cable box, and the like. The AV devices are in communication with at least one of the television set 50 and the control module 52.

The host center 16 includes one of a plurality of host center terminals 108 including appropriate hardware 110, software 112 and communications links 114 to enable connectivity between the first and second stations 12, 14.

Optionally, the health management system 10 includes an information or third station 120 which provides access to the patient information to the authorized users, such as selected family members and friends, via an access terminal 122 connected to a third server 124. The examples of the access terminal 122 are a personal computer, a video display including a control module, a PDA, a portable computer, a cellular telephone, and the like. The connection of the third station 120 to the host center 16 may be via a third link 126 wired or wireless connection.

With continuing reference to FIG. 1 and further reference to FIG. 2, the measurements taken with the medical devices 82₁, 82₂ are associated with the patient with an association means or device or algorithm or computer routine 130 which is external to the medical devices 82₁, 82₂, e.g. the association means 130 is not included with the medical devices 82₁, 82₂, . . . . More specifically, a measurement or monitoring session 132 is started 134 by the patient or user. For example, the patient switches the user interface to a measurement mode and hits a start switch 140, such as a push button, an icon on a touch screen, and the like. Each patient identifies 142 herself to an identification device 144 using a computer terminal, remote device 70, interactive TV 50, or the like. For example, the patient selects a box 146 on the display 54 that is marked with this patient's identification, e.g. name. In response to receiving patient identification, the identification device 144 triggers a start 150 of data acquisition session by the medical devices 82₁, 82₂. The association device 130 receives the physiological data or measurements collected by the measurement devices and associates 152 the physiological data collected by the medical devices 82₁, 82₂ with the entered patient identification. Of course, it is also contemplated that the patient identification can be entered via other means such as patient identification cards or any other devices that transmit patient identification. The measurement data, which is associated with each individual patient, is stored 154 in a storage 156. In this manner, after the monitoring session 132 is started, all subsequent readings are attributed to the patient associated with the session until the session is closed 158 or times out. For example, the patient activates a stop session push button 160 on the display 54. The association means 130 disassociates 162 the identified patient from the medical devices 82₁, 82₂. In this manner, the measurements of a plurality of patients are associated with each respective patient and stored. Subsequently, the measurement data is extracted from the storage 156 based on the identity of the individual patient and transmitted, for example, to the host station 16. Of course, the measurements can also be sent in real time directly to the host center.

With reference to FIGS. 3, 4 and 5, the physiological readings can be taken without regard to which patient the readings belong. A sorter 170 sorts the readings later between the patients. More specifically, the monitoring session 132 is started 134. At the same time, the data acquisition session starts 150. The physiological measurements of the patient are taken and stored 172 in the storage 156. The monitoring session 132 is closed 158 by the user activating the stop pushbutton 160 or by a timer. Later on, a sorting session 174 is open 176. The sorting session 174 may be opened by the patient or the third party on the user interface 48, the first station terminal 20, the host center terminal 108, the third station terminal 122, or at any other appropriate network terminal. For example, the patient recalls 178 the measurement data to be displayed on the display 54. The patient uses the remote device 70 to identify 180 her measurement data as the patient has the knowledge about the time and day when the measurements were taken. As another example, the medical professional can identify the measurement data via a telephone call.

In one embodiment, in which the readings between the patients are typically very different, the sorter 170 sorts the readings automatically to identify the reading with the correct patient. The sorter may be provided with differentiation on parameters or may use a logic program that “learns” to differentiate the patients. The association device 130 associates 152 the measurement data with the identified individual patient or if there is ambiguity, asks for manual classification. The measurement data, which is associated with the patient, is stored 154 in the storage 156.

In another embodiment, the gateway 84 is located in a communal location, such as a pharmacy. A large number of patients can individually use the same monitoring device at the pharmacy to take various physiological readings and again associate those readings with the correct patient. The physiological readings taken at such communal stations are sent for processing, for example, to at least one of the first, second, third stations or any other appropriate processing unit.

With reference to FIG. 6, the survey server 78 generates unique surveys which are the content controlled or regulated by feedback from the patient or user identified in the manner described above. In the example system 10 of FIG. 6, the feedback paths include the user interface 48 that enables the identified user to provide responsive input to the survey server 78. Feedback provided by the user interface 48 may include answers to questions posed by the content, or answers to surveys, quizzes, tests, questionnaires, or the like. The feedback paths may also include one or more biometric devices 82 that monitor biometric or physiological parameters of the patient.

At least one of the measurement server 76 and survey server 78 receive respective responsive inputs via a respective first and second feedback paths 220, 222. Optionally, first and second pre-processors 230, 232 of the respective measurement and survey servers 76, 78 may perform pre-processing of the input before using it for controlling content flow.

In one embodiment, the patient interface 48 receives reflexive surveys. The survey server 78 generates reflexive surveys based on objective or subjective data, such as how one feels, abnormal vital signs, clinically significant data, or a prior completed (or not completed in time) survey. Reflexive surveys are initiated by rules applied to the patient physiological measurements by the monitors 82₁, 82₂, . . . and patient responses to subjective questions. The user interface 48 enables the patient to start the survey session, identify herself and input answers to the survey. The survey answers represent a portion of the second feedback path 222 via which the survey answers associated with a particular patient are forwarded to the survey server 78.

More specifically, the survey server 78 generates the reflexive survey based on one or more triggering events in the monitored vital signs measurement data which is included in the first feedback path 220 and forwarded to the measurement server 76. For example, for a patient having an abnormal heart rate, the survey server 78 generates a reflexive survey designed to query the patient about his heart or other conditions such as a change in a lifestyle that might have affected the heart. The survey server 78 customizes the reflexive survey on a dynamic basis and/or uses previously developed questions and answers accordingly to the triggering event which generates the item of interest. For example, the item of interest includes any aspect of the patient that is deemed interesting, including any abnormal or medically significant data, patient diagnosis information, patient mental or physical state.

As another example, the survey server 78 generates unique surveys for the patient based on at least one of the first and second reported feedback, on a patient profile 234 and pre-configured thresholds. The preconfigured thresholds used by the survey server 78 can be of absolute value or a percentage of change from a previous value. The threshold could apply to a ‘score’ of some other subjective data (such as answers to a previous survey).

With continuing reference to FIG. 6, the educational server 80 automatically delivers educational content related to the surveys, vital sign measurements, health evaluation, or so forth. The educational content is arranged a plurality of content sessions 240, 242, . . . cooperatively directed toward achieving a patient health management educational goal. For example, different content sessions may be provided that are directed toward: reducing weight; stopping smoking; learning to follow a dietary restriction such as a low-salt diet; learning to follow a dietary requirement such as a high-fiber diet; performing a physical exercise; and so forth. The number of content sessions 240, 242, . . . can vary between one content session, to five, ten, or more content sessions. The content sessions can include various types of content, Such as: pre-recorded audio/video content; textual content; interactive survey, quiz, questionnaire, or test content; pre-recorded step-by-step interactive audio/video content; and so forth.

Educational content is delivered to the user by a rules based content flow engine 246 based on at least the first feedback input 220 received by the measurement server 76 and optionally pre-processed by the first pre-processor 230, and the second feedback input 222 received by the survey server 78 and optionally pre-processed by the second pre-processor 232, patient profile 234, and further based on content flow rules. The user typically starts an educational session by identifying herself, for example, on the user interface 48 as described above. Alternatively, sessions can be started automatically based on the monitored physiological conditions.

With reference again to FIG. 1, the user interface 48 can employ substantially any hardware capable of providing content presentation in unmodified and/or augmented form and capable of providing feedback to the second server 42. For example, the user interface 48 can be embodied by hardware such as: a desktop computer; a laptop computer; a personal data assistant (PDA); a cellular telephone (i.e., cellphone); a television set having Internet connectivity integrally included and operated by a television remote control or other input device; a digital or analog television set having Internet connectivity provided by an add-on set-top unit and operated by a television remote control, set-top unit remote control, or other input device; or so forth. The components of the second server 42 can be embodied in various ways, such as by a centralized computer or computer server, a desktop computer, or so forth.

With reference again to FIG. 1 and further reference to FIG. 7, in a relatively centralized example arrangement of components of the health management system 10, the second server 42 is a centralized server that services in the manner described above the patients at second station locations 14₁, 14₂, . . . , 14ₙ. The number of patients of each station can be one, two, three or more patients such as a large number of patients at the communal station. Each patient has a corresponding personalized patient profile 234₁, 234₂, . . . , 234ₙ. For example, patients with the profiles 234₁, 234₂ are assigned to a first station 14₁, patient with a profile 2343 is assigned to a second station 14₂, and so forth. Communication between the patients and the remote centralized second server 42 is achieved by the second link 56 such as a wired or wireless network connection. For example, the second link 56 can be a secure high-speed wireless or wired Internet link. The second link 56 is advantageously a secure link because private medical information may be conveyed across the second link 56. However, unsecured connections can also be used. In some embodiments, a patient may have more than one user interface. For example, if the second server 42 is accessible by a high-speed Internet connection, then the user may be able to access the second server 42 via the patient's home computer, personal data assistant (PDA), Internet-enabled cellular telephone, television set having Internet connectivity integrally included and operated by a television remote control, television set having Internet connectivity provided by an add-on set-top unit and operated by a television remote control, or other Internet-capable device. If the second server 42 is accessible by a cable television network, cellular telephone network, or so forth, then the user may be able to access the second server 42 by a respective cable television set, cellular telephone (i.e., cellphone), or so forth.

With reference to FIG. 8, in a relatively decentralized example arrangement of components of the health management system 10, the second server 42 and the user interface 48 are embodied by a computer 250, personal data assistant (PDA), or other digital electronic device disposed at the dwelling of the patient or carried with the patient or otherwise readily accessed by the patient. The medical content can be downloaded from the first station terminal 20 via a cable or satellite television network, cellular telephone network, the Internet, or otherwise loaded onto the patient's computer 250, smart television, PDA, cellphone, or other device. Although two patient profiles are illustrated, e.g. there are two patients who are assigned to the station illustrated, it is contemplated that a plurality of patients can be assigned to such centralized station.

The centralized and decentralized arrangements or layouts of components of the health management system 10 depicted in FIGS. 7 and 8 are illustrative examples. Other arrangements can be used. For example, in some embodiments certain portions of the second server 42 may reside at a centralized server computer while certain other portions of the second server 42 may reside at the patient's computer. For example, the server may be located on a centralized server computer at the hospital or other centralized location and store the content sessions and patient profiles for a number of patients, but the rules-based content flow engine 246 may be an executable program downloaded to and executing on the patient's computer located at the patient's dwelling. In some embodiments, duplicate copies of portions of the second server 42 or portions thereof may reside at both a centralized server computer and the patient's computer. As an example of this latter arrangement, the patient's biometric measurements may be stored at the patient's computer for ready access by the patient, and also transmitted to a centralized server computer for review by the doctor.

It should be appreciated that the above description, while directed to associating measurement data with a specific patient, and thereby incorporating the measurement data with the correct care plan, such a system can be deployed in a robust system that provides for multiple users to share a station. For example, each care plan must have an association means to allow for restricted access to only those with the correct authorizing credentials. In some cases, this can be a password, while other cases, Such as use of remote devices, the password can also be accompanied with a device registration and verification process. In addition, other types of identification can be used, such as voice recognition, retinal identification, fingerprint recognition, card reader, and other types of biometric, electronic, and physical security.

Once a patient has entered the password or passcode into the system, such as through a user interface 48, the corresponding care plan is retrieved and the patient can review content, historical data, communications, assessment data, and the various goal modules associated with the care plan, including monitoring sessions. In some instances, a secondary password or passcode can be provided for use by care providers or family members who are looking after a patient. In such cases, entry of the secondary password or passcode would provide the user with limited access to information on historical data, communications content, assessment data and the various goal modules, including monitoring sessions. The amount of access allowed can be set by the patient, by the care plan designer, or by a care provider with the proper authority. For example, a patient may want privacy for certain illnesses or for their communications, but may allow access of other purposes. In other cases, the limited access may vary depending on the patient's desire, the person given access, the type of illness, the patient's capacity, or other such factors.

It should be appreciated that the application can also be used with many more than 2 users on the same piece of hardware. Such applications could be in nursing homes, where all the residents access the same hardware set; residential homes, where 3 generations (children, parents, grandparents) receive health experiences over the same hardware; rural posts, where broadband technology cannot reach each home and it is instead installed at a central post and the patients come to it (this situation often exists in farmland, heavily forested areas, dessert areas, mountainous areas, and other like distributed environments), and. retail environments where patients congregate (such as drugstores or retailers).

It should be appreciated that while this disclosure generally describes a station for receiving and transmitting data, such term is not meant to limit the scope of the application to a stationary device, such as a set-top-box, and thus may be applicable to other devices, such as mobile, transportable and remote devices. Consequently, it should be appreciated that any of these devices can be used as included within the scope of the claims.

The above has been described with reference to the preferred embodiments. Obviously, modifications and alterations will occur to others upon reading and understanding the preceding detailed description. It is intended that the above be construed as including all such modifications and alterations insofar as they come within the scope of the appended claims or the equivalents thereof.

1. A health management system (10) comprising:
a user interface (48) which enables an entry of a patient identification; and
an association device or means (130, 152) which associates the biometric data acquired by medical monitoring devices (82₁, 82₂, . . . ) with the entered patient identification.

2. The system as set forth in claim 1, further including:
a plurality of medical monitoring devices (82₁, 82₂, . . . ) which devices lack identification components, each medical monitoring device (82₁, 82₂, . . . ) configured to acquire biometric data of one or more patients.

3. The system as set forth in claim 1, further including:
an identification device or means (130, 132, 142, 144) which opens a patient biometric data acquisition session when the patient identification is entered.

4. The system as set forth in claim 3, wherein the association device or means (130, 152) associates all biometric data acquired. for a predetermined period of time following opening of the data acquisition session with the identified patient.

5. The system as set forth in claim 3, further including:
a session stop device or means (158, 160) which stops the biometric data acquisition session and automatically disassociates the identified patient from the medical monitoring devices (82₁, 82₂, . . . ), after which disassociation the disassociated medical monitoring devices are ready for use by another patient.

6. The system as set forth in claim 1, further including:
a sorter (170, 174) which enables a subsequent manually entered patient identification of the biometric data acquired previously from a plurality of patients, the association device or means (130, 152) associating the biometric data acquired by the medical monitoring devices (82₁, 82₂, . . . ) with the subsequently entered patient identification.

7. The system as set forth in claim 1, further including:
at least one feedback path (82₁, 82₂, 220, 222) providing at least one input which includes an item of interest from the identified. patient; and
a content flow engine (246) including content flow rules which is configured to automatically start presentation of educational content sessions (240, 242) based on at least on the item of interest and content flow rules when the patient identifies herself, each content session (240, 242) being directed toward achieving a health management goal.

8. The health management system as set forth in claim 7, wherein the at least one feedback path is provided. by the medical monitoring device (82₁, 82₂, . . . ), the at least one input including biometric data acquired by the medical monitoring device.

9. The health management system as set forth in claim 7, further including:
a survey server (78), which generates a reflexive survey in response to triggering event in the biometric data which is acquired from the identified patient.

10. A health management system comprising:
a plurality of biometric devices (82₁, 82₂, . . . ) which is disposed at a patient station (14) to acquire medical biometric data of patients;
a measurement gateway (84) which is assigned to the patient station (14) and is in operative communication with the biometric devices (82₁, 82₂) of the patient station (14) to transmit the acquired medical biometric data of the patients to a remote station (12, 16);
an external device (48, 144, 170) which enables a manual entry of a patient identification by a user, the external device (48, 144, 170) being disposed externally to the biometric devices; and
an association computer routine (130, 152) which associates the biometric data acquired by each biometric device (82₁, 82₂) with the entered patient identification.

11. The system as set forth in claim 10, wherein the association computer routine (130, 152) at least one of:
associates subsequently acquired patient data with a previously manually entered patient identification; and
associates previously acquired patient data with a subsequently manually entered patient identification.

12. The system as set forth in claim 10, wherein the association computer routine (130, 152) further:
receives the manually entered patient identification;
receives the acquired biometric data;
associates the acquired biometric data with the identified patient; and
automatically disassociates the identified patient from the medical devices when the biometric data acquisition session is one of manually closed and timed out.

13. A health management method comprising:
acquiring biometric data of one or more patients with biometric medical devices which lack identification components; and
associating the biometric data acquired by the medical devices with a patient identification.

14. The method as set forth in claim 13, wherein the patient identification is entered prior to the step of acquiring biometric medical data and further including:
triggering a biometric medical data acquisition session after the patient identification is entered on a user interface.

15. The method as set forth in claim 14, wherein the step of associating includes:
associating the biometric data acquired for a predetermined period of time with the patient who is identified on the user interface.

16. The method as set forth in claim 14, further including:
exiting the biometric data acquisition session; and
disassociating the identified patient from the medical devices.

17. The method as set forth in claim 13, wherein the step of entering the patient identification includes:
subsequently to the step of acquiring the medical biometric data, identifying the acquired medical biometric data by each patient; and
associating the identified medical biometric data with a respective patient.

18. The method as set forth in claim 13, wherein the step of entering the patient identification includes:
subsequently to the step of acquiring the medical biometric data, automatically sorting the acquired medical biometric data by comparing newly acquired. medical biometric data of each patient to corresponding previously acquired medical biometric data of a respective patient;
identifying the medical biometric data of each patient; and
associating the identified medical biometric data with the respective patient.

19. The method as set forth in claim 13, further including:
starting a monitoring session of the patient;
manually entering the patient identification on a user interface;
triggering a biometric medical data acquisition session after the patient identification is manually entered;
associating the acquired biometric data with the identified patient;
closing the biometric data acquisition session;
automatically disassociating the identified patient from the medical devices when the biometric data acquisition session is closed; and
reviewing the acquired biometric data.

20. The method as set forth in claim 19, further including:
based on the review of the biometric data of the identified patient, one of:
generating a survey directed to the identified patient; and
generating an educational content session directed to the identified patient.

21. A health management system that performs the method of claim 13.

22. A control module comprising:
a gateway (84) which receives patient medical information from medical devices (82₁, 82₂, . . . );
an external device (48, 144, 170) which enables a manual entry of a patient identification, the external device (48, 144, 170) being disposed externally to the medical devices (82₁, 82₂, . . . ); and
an association device (130, 152) which associates the received patient medical information with the manually entered patient identification which is entered one of prior to receiving the medical patient information and subsequent to receiving the patient medical information.

23. A health management system comprising:
a patient station that allows for access to medical information by more than one patient;
a user interface that enables an entry of a patient specific password or passcode that enables access to a particular patient care plan or patient data; and
a display that presents the accessed patient care plan or patient data.

24. The health management system of claim 23 further comprising a second interface located on a second device, wherein the second interface can be used to enter the patient specific password or passcode.

25. The health management system of claim 23 wherein a secondary password or passcode can be entered to enable access to a particular patient care plan or patient data.

26. The health management system of claim 25, wherein the secondary password or passcode enables access limited access to a particular patient care plan or patient data.
